(19) United States
(12) Patent Application Publication
(10) Pub. No.: US 2017/0085682 A1
(43) Pub. Date: Mar. 23, 2017

(54) METHOD AND SYSTEM FOR INTERCHANGEABLE NETWORK COMMUNICATIONS PROTOCOL CONFIGURATIONS

(71) Applicant: Audio-Technica U.S., Inc., Stow, OH (US)

(72) Inventors: Jacquelynn A. Green, Streetsboro, OH (US); Robert T. Green, III, Streetsboro, OH (US); Brian K. Fair, Boyds, MD (US)

(21) Appl. No.: 15/272,158

(22) Filed: Sep. 21, 2016

Related U.S. Application Data
(60) Provisional application No. 62/222,088, filed on Sep. 22, 2015.

(51) Int. Cl. H04L 29/06; H04L 29/08

(52) U.S. Cl. CPC H04L 69/03; H04L 67/327

(57) ABSTRACT

One embodiment provides a method comprising determining which network protocol of multiple types of network protocols to utilize. The method further comprises arbitrating and providing an adjusted set of operational conditions compatible with the network protocol determined, and generating a networked signal compatible with the network protocol determined.

### CROSS REFERENCE TO RELATED APPLICATIONS

This application claims priority from U.S. Provisional Patent Application Ser. No. 62/222,088, filed on Sep. 22, 2015, incorporated herein by reference.

### TECHNICAL FIELD

One or more embodiments relate generally to digital audio and video networking, and in particular, a method and system for interchangeable network communications protocol configurations.

### BACKGROUND

Electronic devices capable of receiving input may utilize network protocols, such as Digital Audio Network Through Ethernet (Dante), Audio Video Bridging (AVB), Ravenna, or other network protocols that are not yet standardized. Different types of network protocols exist, but operation of equipment may not be interchangeable.

A mixing console may include slots for receiving an interchangeable network protocol card to build or select various configurations. As network protocols change over time, however, providing completely integrated and application specific network protocol cards are more costly and less useful to customers. Further, such network protocol cards may consume more power, create more unwanted electromagnetic interference (EMI), and limit signal performance. Microphones, wireless microphone systems, and other professional audio systems do not provide support for building or selecting various configurations.

### SUMMARY

One embodiment provides a method comprising determining which network protocol of multiple types of network protocols to utilize. The method further comprises arbitrating and providing an adjusted set of operational conditions compatible with the network protocol determined, and generating a networked signal compatible with the network protocol determined.

These and other features, aspects and advantages of the present invention will become understood with reference to the following description, appended claims and accompanying figures.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example interchangeable network protocol system implemented in a device, in accordance with one embodiment;

FIG. 2 illustrates an example supporting drive circuitry in detail, in accordance with one embodiment;

FIG. 3 illustrates an example protocol-specific application circuitry in detail, in accordance with one embodiment;

FIG. 4 illustrates a flowchart of an example process for providing interchangeable network communications protocol configurations, in accordance with one embodiment; and

FIG. 5 is a high-level block diagram showing an information processing system comprising a computer system useful for implementing the disclosed embodiments.

The detailed description explains the preferred embodiments of the invention together with advantages and features, by way of example with reference to the drawings.

### DETAILED DESCRIPTION

One or more embodiments relate generally to digital audio and video networking, and in particular, a method and system for interchangeable network communications protocol configurations. One embodiment provides a method comprising determining which network protocol of multiple types of network protocols to utilize. The method further comprises arbitrating and providing an adjusted set of operational conditions compatible with the network protocol determined, and generating a networked signal compatible with the network protocol determined.

For expository purposes, the term “network protocol” as used herein refers to a communication protocol for transporting data (e.g., audio and/or video) through a network. There are different types of network protocols. Examples of different types of network protocols include, but are not limited to, Digital Audio Network Through Ethernet (Dante), Audio Video Bridging (AVB), Ravenna, etc. The terms “network protocol”, “network communication protocol”, and “network protocol configuration” may be used interchangeably in this specification.

For expository purposes, the term “device” as used herein refers to a master device, a receiver, or a system component. Examples of a system component include, but are not limited to, a microphone, a wireless microphone, or any other professional broadcast/media system (e.g., a professional audio system, a professional video system, etc.).

One embodiment provides a method and a system that may be implemented in a device to support and accommodate any type of network protocol. One embodiment provides, for any type of network protocol, a clock synchronization signal and signal/circuit conditioning suitable for the network protocol, thereby enabling the device to operate directly via the network protocol.

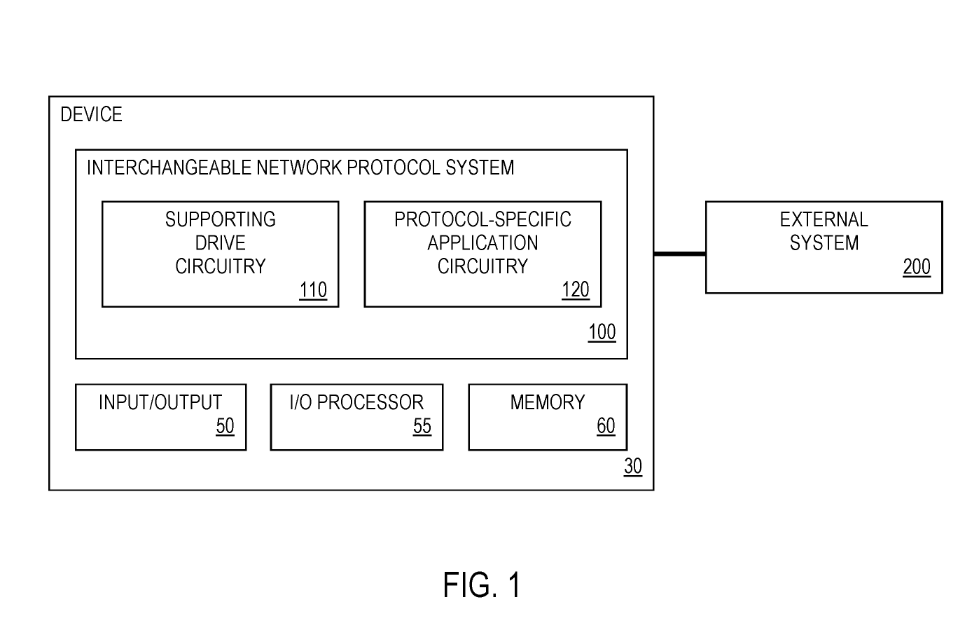

FIG. 1 illustrates an example interchangeable network protocol system 100 implemented in a device 30, in accordance with one embodiment. The system 100 provides a multi-functional platform that enables flexible, efficient, and optimized network communication performance. The system 100 is configured to output a networked signal (e.g., networked audio signal, etc.) compatible with a correct/desired type of network protocol (e.g., correct/desired type of audio network protocol). An external system 200 may interface with the system 100 to receive the networked signal (e.g., networked audio signal, etc.). As described in detail later herein, the system 100 comprises at least the following components: (1) a supporting drive circuitry 110, and (2) a protocol-specific application circuitry 120.

In one embodiment, the device 30 further comprises one or more input/output (I/O) modules 50 a user may interact with. Examples of I/O modules 50 include, but are not limited to, a keypad, a button, a switch, a touch screen, a display screen, etc. The device 30 further comprises an I/O processor 55 configured to receive input from, and send output to, a user. A user may provide input by interacting with an I/O module 50 of the device 30 (e.g., user selection of a button, user interaction with a switch, a touch screen, etc.).

In one embodiment, the device 30 further comprises a memory unit 60 for maintaining data, such as preferred settings, default settings, etc.

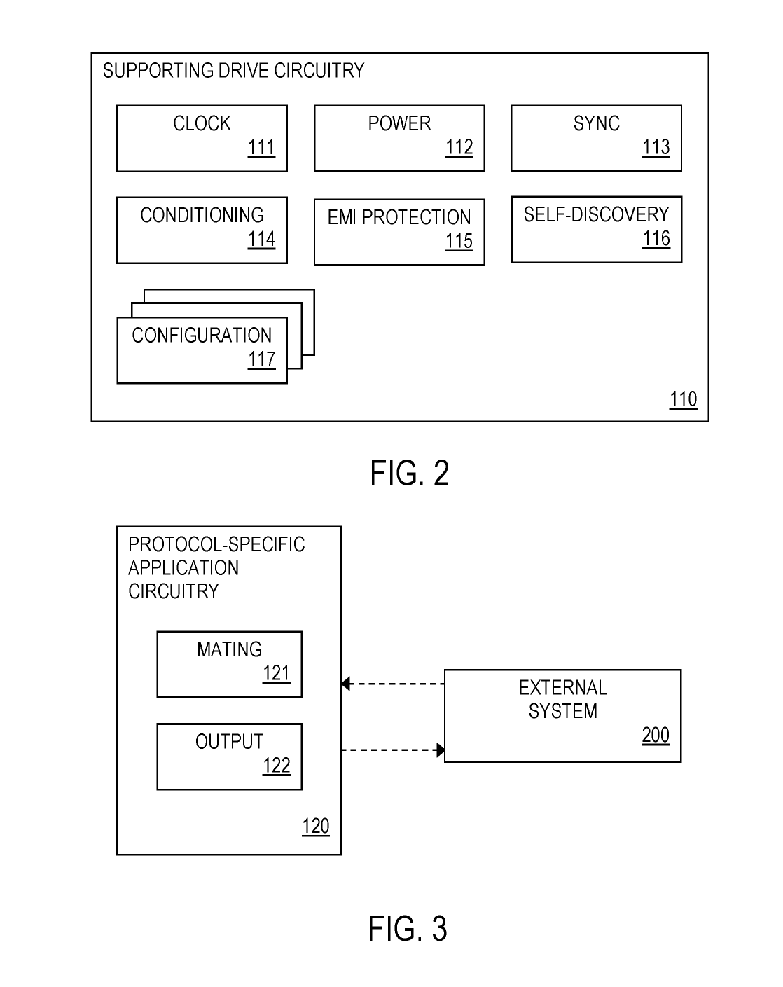

FIG. 2 illustrates an example supporting drive circuitry 110 in detail, in accordance with one embodiment. The drive circuitry 110 may be incorporated/integrated into the device 30. The drive circuitry 110 comprises at least one of the following components: (1) a clock 111 (e.g., for providing a clock signal), (2) a power unit 112 (e.g., for supplying power), (3) a synchronization (“sync”) unit 113 (e.g., for synchronization), (4) one or more conditioning units 114, and (5) an electromagnetic interference (EMI) protection unit 115 (e.g., for reducing/removing unwanted EMI). In one embodiment, the one or more conditioning units 114 provide at least one of the following functionalities: signal/circuit conditioning, noise conditioning, impedance conditioning, etc.

The drive circuitry 110 may comprise one or more additional components, such as, but not limited to, at least one of the following: one or more filters, logic routing and control, and a field-programmable gate array (FPGA), DSP, PIC, or other programmable or control device.

The drive circuitry 110 may employ multiple network protocol configurations that are selectable via various means. In one embodiment, the drive circuitry 110 is configured to determine a correct/desired type of network protocol to utilize. In one embodiment, the drive circuitry 110 determines a correct/desired type of network protocol based on one of the following: (1) user selection, (2) automatic self-discovery, or (3) a build configuration of the installed application circuitry 120.

In one embodiment, the drive circuitry 110 is configured to receive a user selection of a particular network protocol configuration. The particular network protocol configuration may be selected from a set 117 of different types of network protocol configurations available for selection. For example, a user may interact with an I/O module 50 of the device 30 to specify a desired type of network protocol. In response to the user interaction with the I/O module 50, the drive circuitry 110 may receive (e.g., via the I/O processor 55) data indicative of the desired type of network protocol specified by the user.

In one embodiment, the drive circuitry 110 further comprises a self-discovery unit 116 configured to initiate automatic self-discovery of a correct/desired type of network protocol. As stated above, an external system 200 may interface with the system 100 to receive a networked signal. In one example implementation, the protocol-specific application circuitry 120 is mateable with the external system 200. The self-discovery unit 116 may trigger automatic self-discovery of a correct/desired type of network protocol based on information received from the application circuitry 120 when the application circuitry 120 mates with the external system 200.

Utilizing its components (e.g., the one or more conditioning units 114), the drive circuitry 110 is further configured to arbitrate and provide one or more adjusted operational conditions compatible/appropriate for a correct/desired type of network protocol. For example, the adjusted operational conditions may include a clock synchronization signal and/or signal/circuit conditioning information suitable for the correct/desired type of network protocol. Therefore, a network protocol configuration utilized at the drive circuitry 110 may be adjusted (e.g., via user selection, a build configuration of the installed application circuitry 120, or automatic self-discovery) to provide appropriate support for mating with the protocol-specific application circuitry 120.

FIG. 3 illustrates an example protocol-specific application circuitry 120 in detail, in accordance with one embodiment. The application circuitry 120 is configured to output networked signal in accordance with one or more types of network protocols.

In one embodiment, the application circuitry 120 comprises a mating component 121 that enables the application circuitry 120 to mate with an external system 200. The application circuitry 120 further comprises an output unit 122 configured to output a networked signal compatible with a correct/desired type of network protocol. The networked signal is generated based on one or more adjusted operational conditions compatible/appropriate for the correct/desired type of network protocol.

As stated above, in one embodiment, the drive circuitry 110 determines a correct/desired type of network protocol based on a build configuration of the installed application circuitry 120. The build configuration may be adjusted by replacing or exchanging the installed application circuitry 120 with another application circuitry 120, thereby facilitating different types of network protocols.

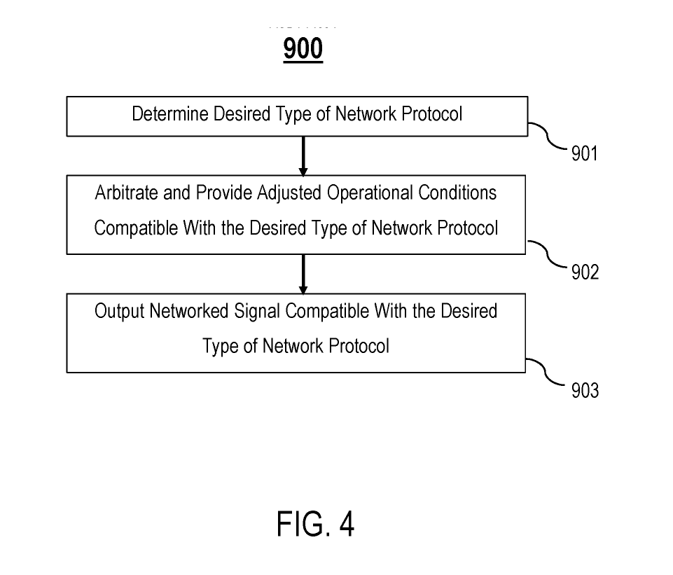

FIG. 4 illustrates a flowchart of an example process 900 for providing interchangeable network communications protocol configurations, in accordance with one embodiment. In process block 901, determine a desired type of network protocol. In process block 902, arbitrate and provide adjusted operational conditions compatible with the desired type of network protocol. In process block 903, output networked signal compatible with the desired type of network protocol.

In one embodiment, the system 100 utilizes at least the drive circuitry 110 and the application circuitry 120 to perform process blocks 901-903.

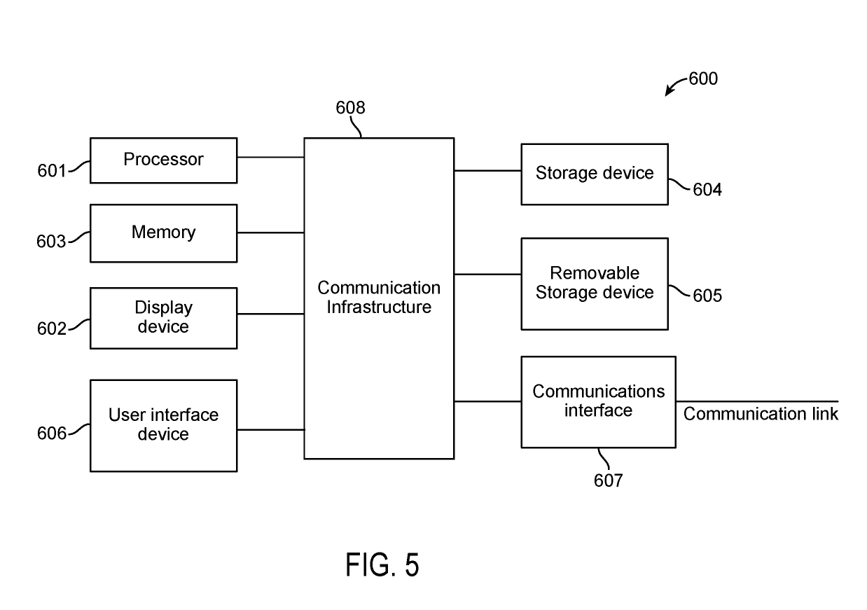

FIG. 5 is a high-level block diagram showing an information processing system comprising a computer system 600 useful for implementing the disclosed embodiments. The computer system 600 includes one or more processors 601, and can further include an electronic display device 602 (for displaying video, graphics, text, and other data), a main memory 603 (e.g., random access memory (RAM)), storage device 604 (e.g., hard disk drive), removable storage device 605 (e.g., removable storage drive, removable memory module, a magnetic tape drive, optical disk drive, computer readable medium having stored therein computer software and/or data), user interface device 606 (e.g., keyboard, touch screen, keypad, pointing device), and a communication interface 607 (e.g., modem, a network interface (such as an Ethernet card), a communications port, or a PCMCIA slot and card). The main memory 603 may store instructions that when executed by the one or more processors 601 cause the one or more processors 601 to perform process blocks 901-904 of the process 900.

The communication interface 607 allows software and data to be transferred between the computer system and external devices. The system 600 further includes a communications infrastructure 608 (e.g., a communications bus, cross-over bar, or network) to which the aforementioned devices/modules 601 through 607 are connected.

Information transferred via communications interface 607 may be in the form of signals such as electronic, electromagnetic, optical, or other signals capable of being received by communications interface 607, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process. In one embodiment, processing instructions for process 900 (FIG. 4) may be stored as program instructions on the memory 603, storage device 604 and the removable storage device 605 for execution by the processor 601.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A method comprising:
determining which network protocol of multiple types of network protocols to utilize;
arbitrating and providing an adjusted set of operational conditions compatible with the network protocol determined; and
generating a networked signal compatible with the network protocol determined.

2. The method of claim 1, further comprising:
outputting the networked signal to a connected external system.

3. The method of claim 1, wherein the network protocol determined comprises an audio protocol, and the networked signal comprises an audio networked signal.

4. The method of claim 1, further comprising:
receiving information from a connected external system; and
based on the information received, initiating automatic self-discovery of a network protocol to utilize.

5. The method of claim 1, further comprising:
receiving a user selection of a network protocol to utilize.

6. The method of claim 1, wherein the network protocol determined is based on a build configuration of an installed protocol-specific application circuitry.

7. The method of claim 1, wherein the adjusted set of operational conditions comprises at least one of a clock synchronization signal and signal conditioning information.

8. A system comprising:
at least one processor; and
a non-transitory processor-readable memory device storing instructions that when executed by the at least one processor causes the at least one processor to perform operations including:
determining which network protocol of multiple types of network protocols to utilize;
arbitrating and providing an adjusted set of operational conditions compatible with the network protocol determined; and
generating a networked signal compatible with the network protocol determined.

9. The system of claim 8, wherein the operations further comprise:
outputting the networked signal to a connected external system.

10. The system of claim 8, wherein the network protocol determined comprises an audio protocol, and the networked signal comprises an audio networked signal.

11. The system of claim 8, wherein the operations further comprise:
receiving information from a connected external system; and
based on the information received, initiating automatic self-discovery of a network protocol to utilize.

12. The system of claim 8, wherein the operations further comprise:
receiving a user selection of a network protocol to utilize.

13. The system of claim 8, wherein the network protocol determined is based on a build configuration of an installed protocol-specific application circuitry.

14. The system of claim 8, wherein the adjusted set of operational conditions comprises at least one of a clock synchronization signal and signal conditioning information.

15. A non-transitory computer readable storage medium including instructions to perform a method comprising:
determining which network protocol of multiple types of network protocols to utilize;
arbitrating and providing an adjusted set of operational conditions compatible with the network protocol determined; and
generating a networked signal compatible with the network protocol determined.

16. The computer readable storage medium of claim 15, the method further comprising:
outputting the networked signal to a connected external system.

17. The computer readable storage medium of claim 15, wherein the network protocol determined comprises an audio protocol, and the networked signal comprises an audio networked signal.

18. The computer readable storage medium of claim 15, the method further comprising:
receiving information from a connected external system; and
based on the information received, initiating automatic self-discovery of a network protocol to utilize.

19. The computer readable storage medium of claim 15, the method further comprising:
receiving a user selection of a network protocol to utilize.

20. The computer readable storage medium of claim 15, wherein the adjusted set of operational conditions comprises at least one of a clock synchronization signal and signal conditioning information.
